(19) United States
(12) Patent Application Publication
(10) Pub. No.: US 2018/0290704 A1
(43) Pub. Date: Oct. 11, 2018

(54) MOTION DETECTION AND LIGHTING SYSTEM

(71) Applicant: Sears Brands, L.L.C., Hoffman Estates, IL (US)

(72) Inventors: Lior Grinfeld, Rosh-Hayin (IL); Gil Fuchs, Nes Tziona (IL)

(21) Appl. No.: 15/483,571

(22) Filed: Apr. 10, 2017

(51) Int. Cl. B62J 6/00

(52) U.S. Cl. CPC B62J 6/005; B62J 2006/006

(57) ABSTRACT

A motion detection and lighting system to improve the visibility and safety of a person operating equipment while moving through space is disclosed herein. The motion detection and lighting system includes at least: a motion detection module, controller, and lighting system that are configured to be communicatively coupled to one another and attached to a person. The motion of the person is detected and the one or more lights in the lighting system are configured to be activated for illumination based at least in part on the motion of the person operating the equipment while traveling through space.

### TECHNICAL FIELD

The present invention relates generally, but not exclusively, to a system and method to detect the motion of a person operating equipment while moving through space, and more particularly to a system and method for illuminating lights attached to the person when the motion of the person operating equipment indicates a change in direction or acceleration.

### BACKGROUND

The illumination of lights on equipment (e.g., motor vehicles, heavy machinery) has historically been performed by devices directed by user input. However, users of the equipment often times forget to signal. Moreover, the lights illuminated on the equipment may have poor visibility in certain environments. Thus, there exists a need for a system and method (separate and independent from the lights that come manufactured on the equipment) to improve the visibility and safety of persons operating the equipment while moving through space (e.g., driving on a road). The illustrative embodiments described below provide improved visibility and safety by employing a motion detection and lighting system to detect the motions of a person operating equipment while moving through space, analyzing the data associated with the detected motions, and then instructing a lighting system to illuminate one or more lights based on the analysis. The system and method described herein can also be implemented in connection with various other transportation technologies or sporting activities (e.g., skiing, mountain biking).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Typically, a person operating equipment while moving through space has to input or manually direct the equipment to indicate the person's intention of turning. That is, the person has to manually activate a light switch on the equipment before the person intends to turn. However, once the lights are activated, others who are also traveling in the same area may have difficulty seeing the lights. Also, in some instances, the person may forget to input directives to the equipment to illuminate the lights before making a turn. Furthermore, a stop signal on the equipment may malfunction when the user steps or grasps on the brakes. This could create an unsafe environment, particularly for a person riding a motorcycle, for instance, who shares the road with other transportation vehicles.

Thereby, one way to increase the visibility and safety of a person while operating equipment and moving through space is to incorporate a motion detection and lighting system that includes a motion detection module configured to detect the motion of the person operating the equipment and illuminate one or more lights in a lighting system based at least in part on the detected motion of the person. The motion detection module includes a plurality of sensors and is configured to receive data indicative of the person's motion. Specifically, the motion detection module is configured to analyze data from the plurality of sensors to determine whether the person intends to make a change in direction or acceleration. Based on this determination, instructions are then sent to activate lights in a lighting system that is attached to the person's body or an article of clothing worn by the person.

In illustrative examples of the present disclosure, a system and method are provided for illuminating one or more lights based at least in part on a person's motion while operating equipment and traveling through space. According to one particular implementation, a system includes one or more lights attached to the person, a motion detection module including a plurality of sensors, and a controller communicatively coupled to the motion detection module and the one or more lights. The controller is configured to receive data indicative of the motion of the person operating equipment while moving through space from the plurality of sensors, determine a change in direction or acceleration associated with the motion of the person operating equipment while moving through space based on the data received, and activate the one or more lights for illumination based at least in part on the determination.

According to another particular implementation, a method for illuminating one or more lights based at least in part on a person's motion while operating equipment and traveling through space is disclosed herein. The method includes attaching one or more lights to the person, detecting motion of the person using a motion detection module including a plurality of sensors, providing a controller that is communicatively coupled to the motion detection module and to the one or more lights. The controller further comprises receiving data indicative of the motion of the person operating equipment while moving through space from the plurality of sensors, determining a change in direction or acceleration associated with the motion of the person operating equipment while moving through space based on the data received, and activating the one or more lights for illumination based at least in part on the determination.

According to yet another particular implementation, a system comprises a motion detection module, one or more storage devices configured to store data, and one or more memories having stored thereon computer-readable instructions. The system is configured to receive data from the motion detection module indicative of the motion associated with a person operating equipment while moving through space, in response to the data received, determine a change in direction or acceleration associated with the motion of the person operating equipment while moving through space, and activate one or more lights attached to the person for illumination based at least in part on the determination.

### BRIEF DESCRIPTION OF THE DRAWINGS

The foregoing Summary and the following Detailed Description are better understood when read in conjunction with the appended drawings. In order to illustrate the present disclosure, various aspects of the disclosure are shown. However, the disclosure is not limited to the specific aspects discussed. The following figures are included:

FIG. 1A illustrates an example embodiment of a motion detection and lighting system attached to a person's body while the person rides a motorcycle.

FIG. 1B illustrates a silhouette of a person with the motion detection and lighting system attached to the back and arms of the person.

FIG. 2 depicts a high-level flowchart of a motion detection module, a controller and, a lighting system communicatively coupled to one another.

FIG. 3 illustrates a plurality of sensors communicatively coupled to the motion detection module.

FIG. 4 depicts an exemplary diagram of the lighting system configured to send signals to one or more lights for illumination.

FIG. 5 illustrates a flowchart representing data collected from a gyroscope in the motion detection module and analyzing the data.

FIG. 6 illustrates a flowchart representing data collected from an accelerometer in the motion detection module and analyzing the data.

FIG. 7 illustrates a flowchart of the motion detection module receiving data from the plurality of sensors, analyzing the data, and the controller activating lights based on the analysis.

FIG. 8 depicts an example schematic diagram of a motion detection module, a lighting system, and a controller communicatively connected to a person for end-to-end communication.

### DETAILED DESCRIPTION OF ILLUSTRATIVE EMBODIMENTS

In an environment where a person operates equipment while moving through open space, there exists an increased demand to improve the visibility and safety of these individuals. Thus, a motion detection and lighting system, as described herein, that is configured to detect the motion of the person operating equipment while moving through space and further configured to send signals to illuminate one or more lights in a lighting system attached to the body of the person based on the person's motion may be advantageous. This motion detection and lighting system is configured to operate separate from the lighting system that comes manufactured on the equipment.

The various examples used in this disclosure are in the context of the design and development of the safety of a person in transportation context, but it should be understood that the described principles may be applied to other developmental scenarios involving the communication between devices in a communications network. Such examples in the field of lighting devices include motion detection and home lighting systems, motion detection and office lighting systems, and/or motion detection and lighting systems associated with outdoor sports. Additionally, the disclosure may be applicable in other industries.

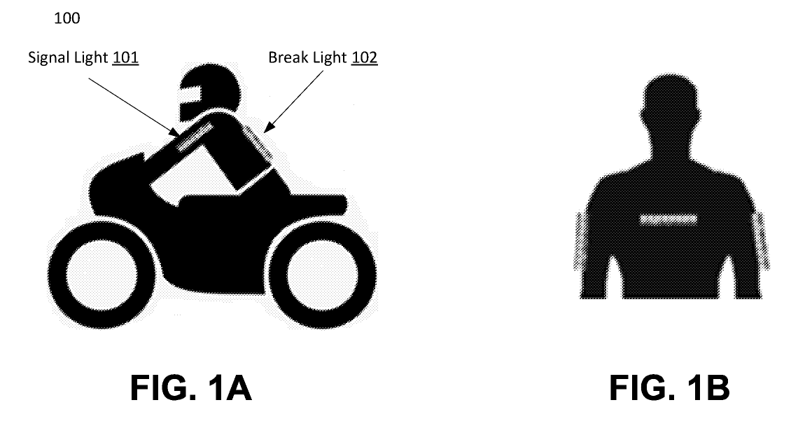

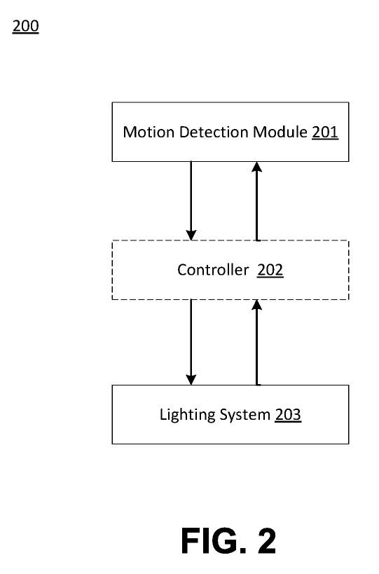

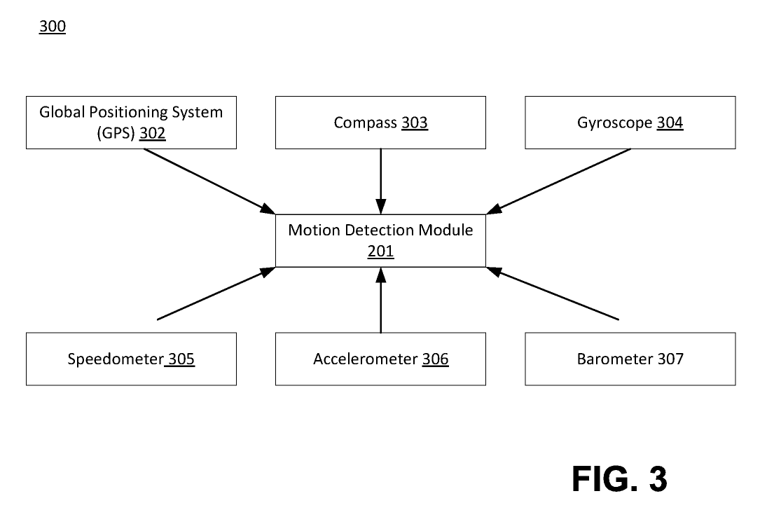

FIG. 1A illustrates a person equipped with a motion detection and lighting system 100 attached to the body of the person while riding a motorcycle. The motion detection and lighting system 100 includes both a motion detection module (not depicted here in FIG. 1A, but described in more detail in FIGS. 2-3) and a lighting system that includes at least: a signal light 101 and a break light 102. The signal light 101 in FIG. 1A is attached to the arm of the person riding the motorcycle (only one signal light is depicted in FIG. 1A, however, in alternate embodiments, there may be another signal light attached to the other arm of the person) and the break light 102 is attached to the back of the person riding the motorcycle. In some instances, the lighting system can be attached to a helmet, backpack, armbands, or some other article of clothing worn by the person.

The signal light 101 is configured to illuminate when the person riding the motorcycle intends to perform a turn. The signal light 101 is configured to flicker when illuminated. The break light 102 is configured to illuminate when the person riding the motorcycle is deaccelerating. In other words, the break light 102 illuminates when the person operating equipment intends to stop by grasping or pressing down on the brakes. The break light 102 is configured to illuminate a steady red light. Moreover, the signal light 101 and backlight 102 are configured to be illuminated in different colors.

Although FIG. 1A illustrates that the person is riding a motorcycle and utilizing the motion detection and lighting system 100, the motion detection and lighting system 100 is also applicable when the person operates a different type of equipment. That is, the motion detection and lighting system 100 is also applicable to a person operating on skis or while riding a bicycle. As such, the person riding a motorcycle and using the motion detection and lighting system 100 as depicted in FIG. 1A is simply just one example embodiment. Other transportation mechanisms or sporting activities could also benefit from the use of the motion detection and lighting system 100 to improve visibility while traveling through space.

FIG. 1B illustrates a silhouette of a person with the motion detection and lighting system 100 attached thereto. That is, FIG. 1B illustrates that the lighting system can be attached to the back and the side of the arms of a person. Additional lights can be added to the system and attached to the person's body for greater visibility. As discussed above, the person in FIG. 1B can use the motion detection and lighting system 100 in a skiing environment. For example, as the person operates skiing equipment and moves downhill on a mountain, the motion detection and lighting system 100 detects the person's motion and automatically activates the one or more lights for illumination. Specifically, the back light in FIG. 1B is configured to be illuminated in red, when activated, to indicate to other skiers that the skier is stopping. This occurs when the skier is decelerating. Moreover, the lights on the arms can be illuminated by flickering a different color (e.g., yellow), when activated, to indicate to others that the skier is turning.

Furthermore, in alternate embodiments, the motion detection and lighting system 100 is configured to detect a person's motion while moving through space without equipment. That is, the motion detection and lighting system 100 can detect a person's motion while the person is walking, jogging, or running. The lighting system can be activated simply based on the person's motion sans equipment.

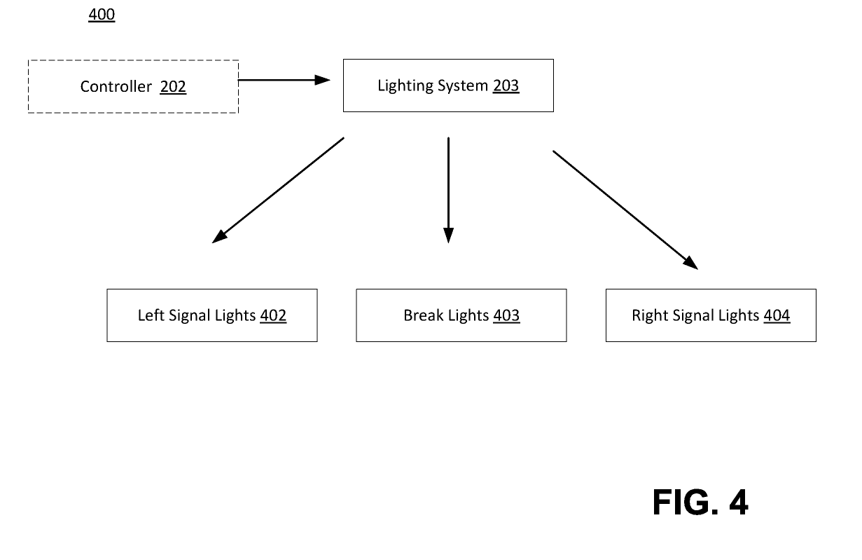

FIG. 2 illustrates a high-level diagram of the motion detection and lighting system 100. The motion detection and lighting system 100 includes at least one of: a motion detection module 201, a controller 202, and a lighting system 203. The motion detection module 201, controller 202, and lighting system 203 are communicatively coupled to one another either through a direct wired connection or via a wireless connection. The motion detection module 201 includes a plurality of sensors to detect a person's motion. As described in more detail in FIG. 3, the motion detection module 201 consists of multiple sensors configured to collect data when a person operating equipment moves through space. The controller 202 may be a part of the motion detection module 201 or it may be a completely separate device. Nevertheless, the controller 202 and the motion detection module 201 are communicatively coupled to one another in some manner. Specifically, in one embodiment, the controller 202 is configured to receive data from the motion detection module 201. The controller 202 then sends signals to the lighting system 203 to illuminate one or more lights based on the data or information received from the motion detection module 201. (The lighting system 203 is described in more detail in FIG. 4.)

FIG. 3 illustrates a diagram 300 of the motion detection module 201 in greater detail. Specifically, FIG. 3 illustrates a plurality of sensors 302-307 communicatively coupled to the motion detection module 201. In one example embodiment, the motion detection module 201, including the plurality of sensors 302-307, is attached to a person operating equipment who moves around in space. Specifically, the motion detection module 201 includes at least: a global positioning system (GPS) 302, compass 303, gyroscope 304, speedometer 305, accelerometer 306, and a barometer 307. The plurality of sensors 302-307 is a non-limiting exemplary list of sensors that are included in the motion detection module 201.

Continuing to refer to FIG. 3, GPS 302 collects data of the person's position and location. The geographical location of the person can be detected and data regarding the person's location can be stored and tracked. Moreover, as shown in FIG. 3, a compass 303 is included in the motion detection module 201 to detect the person's orientation relative to North/South/East/West. That is, the direction of where the person is going is detected via the compass 303. Moreover, a gyroscope 304 is included in the motion detection module 201 to detect the rotation of the person. A speedometer 305 is included to detect a person's speed or velocity while the person operating the equipment is traveling through space. An accelerometer 306 is used in the motion detection module 201 to determine the acceleration of the person operating equipment while moving through space. Furthermore, a barometer 307 is included to measure how high the person is from the surface of earth. That is, the person's height can be detected by the barometer 307. As analyzed above, each of these sensors can be included in the motion detection module 201. Moreover, in some embodiments, the motion detection module 201 can add additional sensors so that more accurate data and measurement of the person's motion can be gathered. For example, the motion detection module 201 can include two accelerometers instead of one for greater accuracy with respect to detecting the person's acceleration.

Additionally, in alternate embodiments, the motion detection module 201 is configured as a part of a separate computing device e.g., smartphone or smartwatch (not depicted in FIG. 3). A smartphone or smartwatch with a motion detection module included therein collects data indicative of the motion of the person operating the equipment while moving through space. The smartphone or smartwatch can also be programmed to identify which of the one or more lights that are attached to the person should be illuminated. In other words, the smartphone or smartwatch is configured to detect the motion of the person, analyze the detected motion, and control the illumination of the lights without the need of a separate motion detection module or controller coupled to a person's body. Simply put, any data indicative of the person's motion is received directly at the smartphone or smartwatch so long as the smartphone or smartwatch is held or carried by the user. After some analysis, the smartphone or smartwatch can then automatically instruct lights in the lighting system to illuminate accordingly.

FIG. 4 illustrates a lighting system that includes one or more lights. Specifically, FIG. 4 illustrates that the lighting system 202 includes at least one of: a left signal light 402, a break light 403, and a right signal light 404. The lighting system 203, as discussed above, is configured to be attached to the person's body or to an article of clothing worn by the person. The motion detection module 201 is configured to detect some change in direction or acceleration of the person and subsequently send a signal to the lighting system 203. Specifically, the controller 202 in the motion detection module 202 sends the signals to the lighting system 203 so that one or more lights 402-404 illuminate. In some instances, the controller 202 may not be necessary and the motion detection module 201 is configured to directly signal to the lighting system 203 which of the lights 402-404 to illuminate. That is, the motion detection module 201 may be configured to receive and process data with respect a person's motion, analyze the received data, and send instructions to the lighting system 203 without a controller.

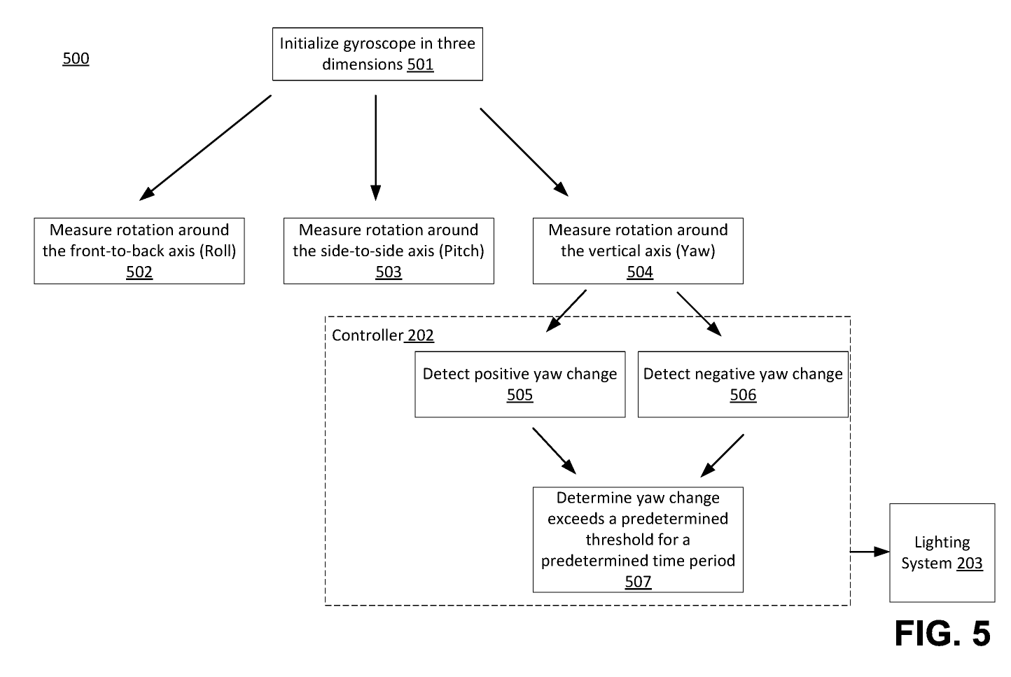

Continuing to refer to FIG. 4, the left signal light 402 and right signal light 404, when activated, are illuminated independently of each other to indicate that the person is turning in one direction and not the other. For example, the left signal light 402 is activated and illuminated when the person's motion is detected to tilt or bank towards the left. And the right signal light 404 is activated and illuminated when the person's motion is detected to tilt or bank toward the right. The detection of tilt and its associated information with respect to the person's intention of turning will be described in greater detail in FIG. 5.

FIG. 5 illustrates a flowchart 500 representing data collected from the gyroscope 304 in the motion detection module 201, analyzing the data via the controller 202, and sending instructions to the lighting system 203. As shown in FIG. 5, the gyroscope in the motion detection module is first initialized 501. That is, orientation of the gyroscope is set up to detect motion in three dimensions (e.g., vertical, longitudinal, and lateral). If the person's motion, for instance, causes the gyroscope to rotate around the front and back (e.g., longitudinal) axis then the gyroscope can detect the “roll” of the gyroscope 502. If the person's motion is detected by the gyroscope to rotate around the side-to-side (e.g., lateral) axis then the gyroscope can detect the “pitch” of the person 503. Moreover, if the rotation of the gyroscope is around the vertical axis, then the gyroscope can detect the “yaw” of the person in motion 504. This detected “yaw” provides the motion detection module with information to identify the person's intent when it comes to turning. That is, if the “yaw” is detected to exceed some predetermined banking value (e.g., 5 degrees) then the motion detection module is able to determine that the person is about to turn either left or right 505, 506. In other words, if there is more than 5 degrees of a “yaw” change in comparison to when the person is in the straight and level position then the motion detection module recognizes that a banked turn is happening.

Once a “yaw” change is detected, the motion detection module further determines whether the state of the “yaw” change reaches quiescence (stable reading) for at least a certain time period 507. Put another way, when the “yaw” change is detected, the time of the “yaw” change is also monitored. Typically, if the “yaw” change both exceeds the predetermined banking value and exceeds a predetermined period of time (e.g., 1/10^{th} of a second) then the motion detection module determines that banked turn has occurred in one of two directions.

Specifically, if the “yaw” is a positive yaw and is greater than 5 degrees for a period of time longer than 1/10th of a second, for example, then the motion detection module recognizes that a left turn has occurred. The controller 202 then sends a signal to activate the left turn signal of the lighting system 203 for illumination. Alternatively, if the “yaw” is negative and exceeds the predetermined banking value of 5 degrees for a period of time longer than 1/10th of a second, then the motion detection module determines that a right turn has occurred. The controller 202 then sends the signal to the right turn signal of the lighting system 203 for illumination.

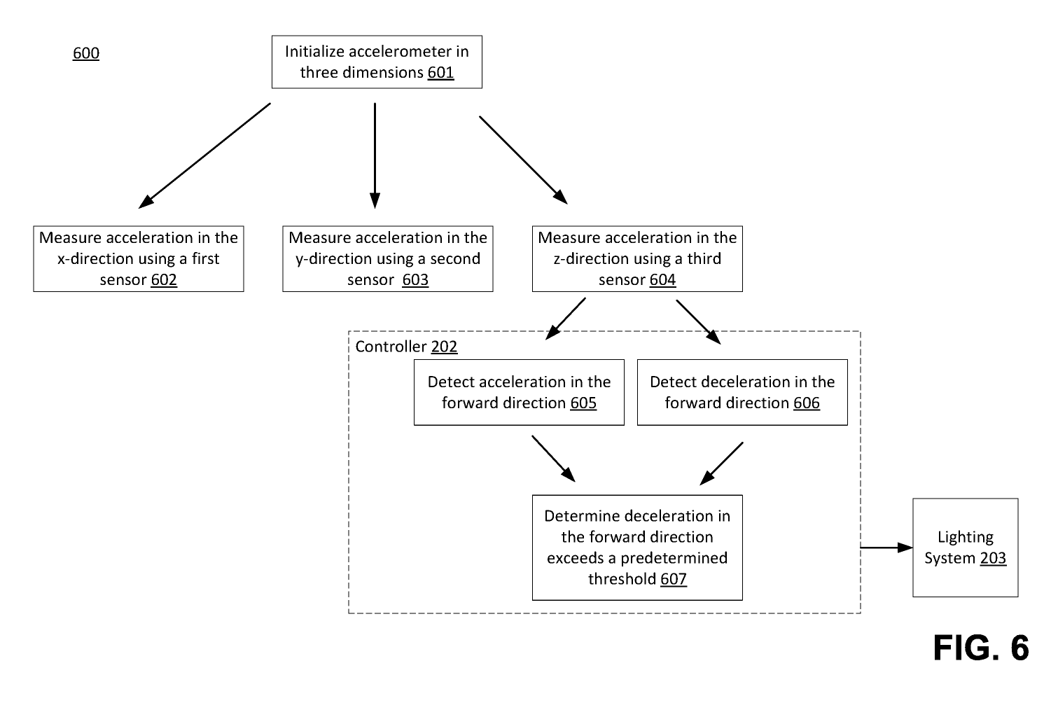

FIG. 6 illustrates a flowchart 600 representing data collected from the accelerometer 306 in the motion detection module, analyzing the data via the controller 202, and sending instructions to lighting system 203. The accelerometer 306 is communicatively coupled to the motion detection module in some manner and collects measurements related to the person's acceleration while operating equipment in open space. In some instances, there may be more than one accelerometer included in the motion detection module for greater accuracy when detecting the person's acceleration.

Continuing to refer to FIG. 6, the accelerometer is first initialized 601. The accelerometer is initialized in three dimensions. The accelerometer 306 measures the person's motion by including at least three sensors and each sensor is configured to measure acceleration in the x-direction 602, in the y-direction 603, and/or the z-direction 604. All three sensors that measure movements from the three directions are positioned orthogonal to each other.

As shown in FIG. 6, in one example embodiment, the z-direction is set up to determine the forward motion of the person. Therefore, if the accelerometer 306 detects that the acceleration in the forward direction is positive then the person is moving forward 605. If the accelerometer 306 detects that the forward direction is negative (e.g., a deceleration) 606 then the controller 202 of the motion detection module can send a signal to the lighting system 203 to activate the break light. However, when deceleration is detected, this deceleration data is first compared to a predetermined threshold value with respect to the gravitational constant (g) 607. For example, if the deceleration data exceeds a predetermined threshold value of −¼*g then the motion detection module indicates to the lighting system 203 that the break light needs to be illuminated.

Again, in some instances, a controller is not necessary to be included in the motion detection module. The motion detection module may be configured to directly instruct the lighting system 203 to illuminate the one or more of the lights based on the detected change of acceleration of the person.

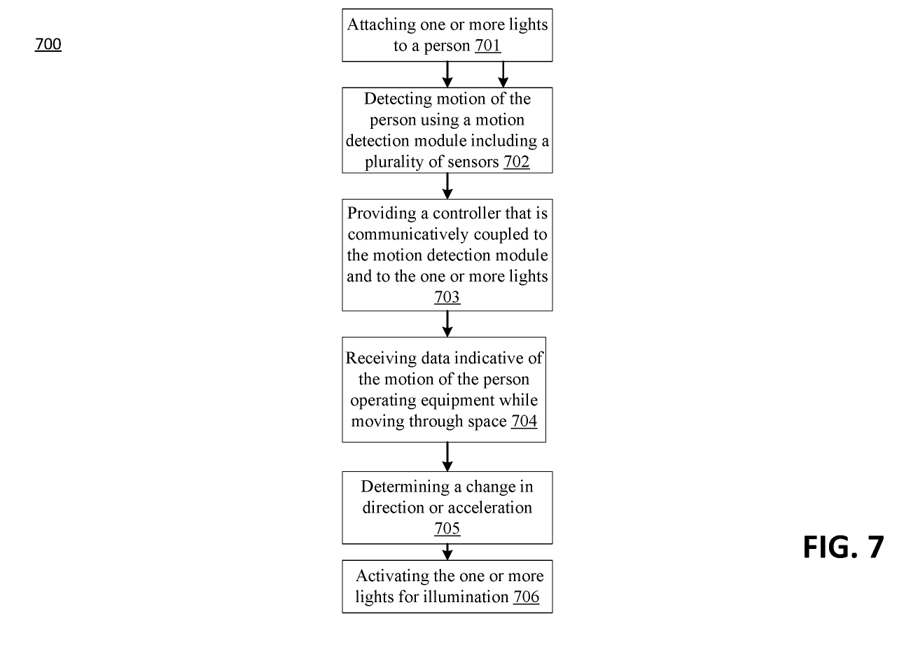

FIG. 7 illustrates a flowchart of the motion detection module receiving data from the plurality of sensors, analyzing the data, and activating lights based on the analysis. Referring to block 701, a lighting system that includes one or more lights is attached to the person's body or to an article of clothing worn by the person. For example, at least one light is attached to the back of the person and at least two lights are attached to the back shoulders of the person. The light attached to the back illuminates at a different color than the lights attached to the back shoulders of the person.

Referring to block 702, a motion detection module that includes a plurality of sensors is also attached to or located on the body of the person. The motion detection module is configured to receive data from the plurality of sensors. The plurality of sensors may include at least one of: a global positioning system (GPS) 302, compass 303, gyroscope 304, speedometer 305, accelerometer 306, and a barometer 307. Each of these sensors is communicatively coupled to the motion detection module and is configured to detect or collect measurements from different motions of the person operating equipment while moving through space. For example, the gyroscope is included in the motion detection module to detect motion in three dimensions (e.g., vertical, longitudinal, and lateral). If the person's motion, for instance, causes the gyroscope to rotate around the front and back (e.g., longitudinal) axis then the gyroscope can detect the “roll” of the gyroscope. If the person's motion is detected by the gyroscope to rotate around the side-to-side (e.g., lateral) axis then the gyroscope can detect the “pitch” of the person. Lastly, if the rotation of the gyroscope is around the vertical axis, then the gyroscope can detect the “yaw” change of the person in motion. This “yaw” detection provides the motion detection module with information to recognize the person's intent when it comes to turning.

Referring to block 703, a controller is included and configured to receive data from the motion detection module. The controller is communicatively coupled to the motion detection module and the lighting system. The controller is configured to receive data from the motion detection module, analyze the data, and direct the lighting system to illuminate at least one of the lights. As analyzed above, in some instances, the controller may not be necessary such that the motion detection module may directly send signals to the lighting system without the controller.

Now referring to blocks 704 and 705, the controller is configured to receive data from the motion detection module and determine if a change of direction or acceleration has occurred. That is, in one embodiment, the controller is configured to detect whether a banking/tilt of the person operating equipment while moving through space has occurred. If, each time, the detected motion is greater than a banking value threshold and exceeds a predetermined period of time then the controller is configured to send instructions to the lighting system. For instance, the controller detects whether a greater than a 5 degrees change in the bank or tilt of the person operating equipment has occurred. If so, the controller then monitors whether this greater than 5 degrees tilt has occurred for longer than 1/10^{th} of a second. And if all of this occurs, the controller recognizes that the person is most likely about to turn or is in the process of turning and the respective signal light, as shown in block 706, associated with the turn should be activated.

Moreover, the acceleration from the person operating equipment is detected and determined whether there is a decline or deceleration. If so, then the person is preparing to or has stopped. The controller of the motion detection module recognizes this deceleration and compares it to a predetermined threshold value ((e.g., −¼*gravitational constant (g)). If the comparison determines that the person is decelerating, the controller directs the lighting system to illuminate the break light and not the turning lights. In some instances, both the break light and at least one of the signal lights are illuminated simultaneously. This occurs when the motion detection module detects that the person has performed both a deceleration that is greater than −¼*g and a tilt motion larger than 5 degrees for longer than 1/10^{th} of a second.

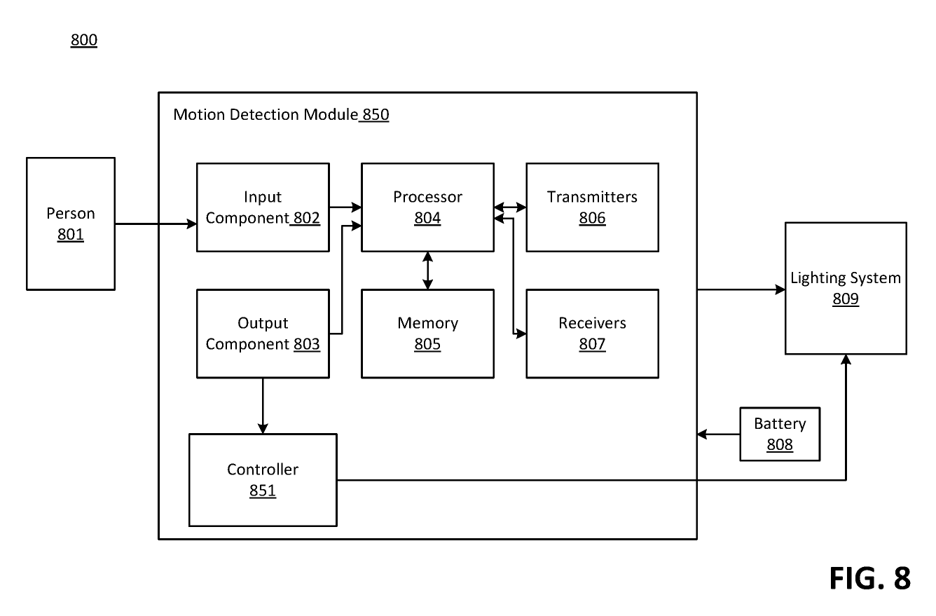

FIG. 8 is an example schematic diagram 800 of a computing device (e.g., motion detection module 850) that is powered by a battery 808. The motion detection module 850 may be communicatively coupled to a controller 851 and a lighting system 809 for end-to-end communication between the motion detection module 850 and a person 801. In one example, a motion detection module 850 may include a processor 804, a memory device 805 coupled to processor 804, one or more wireless transmitters 806, one or more wireless receivers 807, an output component 803, and an input component 802.

Processor 804 includes any suitable programmable circuit including one or more systems and microcontrollers, microprocessors, reduced instruction set circuits (RISC), application specific integrated circuits (ASIC), programmable logic circuits (PLC), field programmable gate arrays (FPGA), and any other circuit capable of executing the functions described herein. The above example examples are not intended to limit in any way the definition and/or meaning of the term “processor.”

Memory device 805 includes a non-transitory computer-readable storage medium, such as, without limitation, random access memory (RAM), flash memory, a hard disk drive, a solid state drive, a diskette, a Flash drive, a compact disc, a digital video disc, and/or any suitable memory. In the exemplary implementation, memory device 805 includes data and/or instructions embodying aspects of the disclosure that are executable by processor 804 (e.g., processor 804 may be programmed by the instructions) to enable processor 804 to perform the functions described herein.

Wireless transmitters 806 are configured to transmit control signals and data signals over a network. In one example, wireless transmitters 806 may transmit in a radio frequency spectrum and operate using an appropriate communication protocol. Moreover, wireless receivers 808 are configured to receive control signals and data signals over network. In one example, wireless receivers 807 may receive signals on a radio frequency spectrum using an appropriate communication program.

The motion detection module 850 may also include at least one output component 803 for sending data or instructions to controller 851. Output component 803 may be any component capable of conveying information to controller 851. In some implementations, output component 803 is communicatively coupled to a separate controller device 851. However, in some implementations, output component 803 is communicatively coupled to controller 851 inside of the motion detection module 850. An output adapter is operatively coupled to processor 804 and is configured to be operatively coupled to an output device, such as a display device (e.g., a liquid crystal display (LCD), organic light emitting diode (OLED) display, cathode ray tube (CRT), “electronic ink” display, or the like) or an audio output device (e.g., a speaker, headphones, or the like).

The motion detection module 850 may also include at least one input component 802 for receiving input from person 801. Input component 802 may include, for example, a keyboard, a pointing device, a mouse, a stylus, a touch sensitive panel (e.g., a touch pad or a touch screen), a gyroscope, an accelerometer, a position detector, an audio input device, or the like. The motion detection module 850 may also be connected to a lighting system 807 that includes one or more illuminated lights. The lighting system 807 may also include its own separate battery for power.

It will be appreciated that in some embodiments the functionality provided by the routines discussed above may be provided in alternative ways, such as being split among more routines or consolidated into fewer routines. Similarly, in some embodiments, illustrated routines may provide more or less functionality than is described, such as when other illustrated routines instead lack or include such functionality respectively or when the amount of functionality that is provided is altered. In addition, while various operations may be illustrated as being performed in a particular manner (e.g., in serial or in parallel) and/or in a particular order, in other embodiments the operations may be performed in other orders and in other manners.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. As used in the description of the disclosure and the appended claims, the singular forms “a”, “an” and “the” are intended to include the plural forms as well, unless the context clearly indicates otherwise. It will be further understood that the terms “comprises” or “comprising,” when used in this specification, specify the presence of stated features, integers, steps, operations, elements, and/or components, but do not preclude the presence or addition of one or more other features, integers, steps, operations, elements, components, and/or groups thereof. Furthermore, the terms “assets” and “computing devices,” when used in this specification, may be used interchangeably.

In general, the various features and processes described above may be used independently of one another, or may be combined in different ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example examples.

It will be understood by those skilled in the art that various changes may be made and equivalents may be substituted for elements thereof without departing from the scope of the teachings herein. In addition, many modifications may be made to adapt the teachings herein to a particular situation without departing from the scope thereof. Therefore, it is intended that the claims not be limited to the particular implementations disclosed herein.

1. A motion detection and lighting system to improve the visibility of a person operating equipment while moving through space, comprising:
one or more lights attached to the person or to an article of clothing worn by the person;
a motion detection module including a plurality of sensors; and
a controller communicatively coupled to the motion detection module and the one or more lights, wherein the controller further comprises instructions that when executed by the controller, cause the controller to:
receive, from the plurality of sensors, data indicative of the motion of the person operating equipment while moving through space;
determine, based on the data received, a change in direction or acceleration associated with the motion of the person operating equipment while moving through space, wherein the instructions to cause the controller to determine a change in direction or acceleration comprise instructions to detect yaw about a vertical axis of the equipment; and
activate, based on the determination, the one or more lights for illumination.

2. The system of claim 1, wherein the one or more lights includes a light attached to the back of the person or article of clothing and at least two lights attached to the back shoulders of the person or article of clothing, wherein the light attached to the back of the person or article of clothing illuminates a different color than the at least two lights attached to the back shoulders of the person or article of clothing.

3. The system of claim 1, wherein the plurality of sensors further comprising:
at least one of: an accelerometer, a gyroscope, a barometer, a speedometer, a global positioning system (GPS), and a compass.

4. The system of claim 3, wherein data indicative of the motion of the person operating equipment while moving through space from the plurality of sensors includes:
data indicative of at least one of: acceleration, tilt, position, location, and change in direction of the person operating equipment while moving through space.

5. The system of claim 4, wherein the controller activates the light attached to the back of the person or article of clothing each time data indicative of acceleration is determined to be greater than −¼*gravitational constant (g).

6. The system of claim 4, wherein data indicative of tilt is compared to a predetermined banking value.

7. The system of claim 4, wherein data indicative of tilt is compared to a predetermined period of time.

8. The system of claim 4, wherein the controller activates one of the two lights attached to the back shoulders of the person or article of clothing each time data indicative of tilt is determined to exceed the predetermined banking value and the predetermined period of time.

9. The system of claim 8, wherein the predetermined banking value is 5 degrees from the initial straight up position of the person and the predetermined period of time is 1/10^{th} of a second.

10. A method to improve the visibility of a person operating equipment while moving through space, comprising:
attaching one or more lights to the person or to an article of clothing worn by the person;
detecting motion of the person using a motion detection module including a plurality of sensors;
detecting yaw about a vertical axis of the equipment using the motion detection module; and
providing a controller that is communicatively coupled to the motion detection module and to the one or more lights, wherein the controller is configured for:
receiving, from the plurality of sensors, data indicative of the motion of the person operating equipment while moving through space;
determining, based on the data received, a change in direction or acceleration associated with the motion of the person operating equipment while moving through space, wherein the step of determining a change in direction or acceleration comprises determining an intent to turn the equipment based on the detected yaw; and
activating, based on the determination, the one or more lights for illumination.

11. The method of claim 10, wherein the one or more lights includes a light attached to the back of the person or article of clothing and at least two lights attached to the back shoulders of the person or article of clothing, wherein the light attached to the back of the person or article of clothing illuminates a different color than the at least two lights attached to the back shoulders of the person or article of clothing.

12. The method of claim 10, wherein the plurality of sensors further comprising:
at least one of: an accelerometer, a gyroscope, a barometer, a speedometer, global positioning system (GPS), and a compass.

13. The method of claim 12, wherein data indicative of the motion of the person operating equipment while moving through space from the plurality of sensors includes:
data indicative of at least one of: acceleration, tilt, position, location, and change in direction of the person operating equipment while moving through space.

14. The method of claim 13, wherein the controller activates the light attached to the back of the person or article of clothing each time data indicative of acceleration is determined to be greater than −¼*gravitational constant (g).

15. The method of claim 13, wherein data indicative of tilt is compared to a predetermined banking value.

16. The method of claim 13, wherein data indicative of tilt is compared to a predetermined period of time.

17. The method of claim 13, wherein the controller activates one of the two lights attached to the back shoulders of the person or article of clothing each time data indicative of tilt is detected to exceed the predetermined banking value and the predetermined period of time.

18. The method of claim 17, wherein the predetermined banking value is 5 degrees and the predetermined period of time is 1/10^{th} of a second.

19. A system, comprising:
a motion detection module;
one or more storage devices configured to store data;
one or more memories having stored thereon computer-readable instructions that, upon execution by a computing device, cause the system at least to:
receive data from the motion detection module indicative of the motion associated with a person operating equipment while moving through space, said data including data representing yaw about a vertical axis of the equipment;
in response to the data received, determine a change in direction or acceleration associated with the motion of the person operating equipment while moving through space; and
activate one or more lights attached to the person based at least in part on the determination.

20. The system of claim 19, wherein the instructions to determine a change in direction or acceleration associated with the motion of the person operating equipment while moving through space comprise instructions to:
compare the data received indicative of the motion associated with the person to at least one of: a predetermined banking value, a predetermined period of time, and a predetermined threshold value associated with the gravitational constant (g).
